(19) United States
(12) Patent Application Publication
(10) Pub. No.: US 2018/0275773 A1
(43) Pub. Date: Sep. 27, 2018

(54) ELECTRONIC ERASER

(71) Applicant: eGalax_eMPIA Technology Inc., Taipei (TW)

(72) Inventor: Shang-Tai YEH, Taipei (TW)

(21) Appl. No.: 15/991,583

(22) Filed: May 29, 2018

Related U.S. Application Data
(63) Continuation of application No. 15/014,459, filed on Feb. 3, 2016.

(51) Int. Cl. G06F 3/038; G06F 3/0354; G06F 3/041

(52) U.S. Cl. CPC G06F 3/0383; G06F 3/03543; G06F 3/0354; G06F 3/0416; G06F 3/03544; G06F 3/03545

(57) ABSTRACT

An electronic eraser includes a carrier defining therein an accommodation chamber, two or three signal transmitters mounted on the border inside the accommodation chamber and one or multiple signal transmitters mounted inside the accommodation chamber between two bordered signal transmitters beyond the midpoint therebetween, and a power supply mounted inside the accommodation chamber and electrically coupled with the signal transmitters to provide the signal transmitters with the necessary working electricity. When going to clear the writing or drawers on a touchscreen the user can move the carrier, enabling the touchscreen to receive and process the signals of the signal transmitters and to clear the writing or drawings on the surface thereof according to the signal processing result, and thus, the invention facilitates the operating convenience.

### CROSS REFERENCE TO RELATED APPLICATIONS

This application is a Continuation of co-pending application Ser. No. 15/014,459, filed on Feb. 3, 2016, for which priority is claimed under 35 U.S.C. § 120, the entire contents of all of which are hereby incorporated by reference.

### BACKGROUND OF THE INVENTION

### 1. Field of the Invention

The present invention relates to electronic eraser technology and more particularly, to such an electronic eraser, which comprises a carrier defining therein an accommodation chamber, at least three signal transmitters mounted inside the accommodation chamber at selected locations and a power supply mounted inside the accommodation chamber and electrically coupled with the signal transmitters to provide the signal transmitters with the necessary working electricity. In application, the user can operate the electronic eraser and move the carrier relative to the touchscreen, enabling the touchscreen to receive and process signals of the signal transmitters and then to clear the writing or drawings on the surface thereof according the result of signal processing, facilitating quick erasing.

### 2. Description of the Related Art

With fast development of modern technology, various advanced electronic products such as smart phone, touchscreen computers and TVs that use a touchscreen instead of a keyboard or keypad for data input have been created and appeared on the market. Instead of the use of a keyboard or keypad in a computer or mobile phone for data input. However, when operating a touchscreen, the user usually will tap on the touchscreen or place a finger on the touchscreen and then move it across the touchscreen. Finger operation is intuitive and convenient; however, it is not necessarily suitable for all occasions. For example, when a user places a finger on the touchscreen and move it across the touchscreen during writing, the user may be unable to achieve heavy or fast input due to greater friction between the finger and the touchscreen. Further, when clicking the icon of an application software program or a virtual key code, the finger may erroneously click two more icons or virtual key codes due to the problem of finger thickness. In order to facilitate writing on a touchscreen and to assist in navigating or providing more precision when using touchscreens, stylus was created.

Normally, there are two types of styluses, namely, the active type and the passive type. A passive stylus is a pen that acts just like a finger for changing the capacitive value when touching a device screen. There is no communication between a passive stylus and a touchscreen. An active stylus is an input device that includes electronic components capable of providing electrical signals to a touchscreen and that allows the user to write directly onto the screen surface of the touchscreen.

An advanced stylus not only can provide electrical signals to a touchscreen and allow the user to write directly onto the screen surface of the touchscreen, but also can provide an erasing signal for enabling the touchscreen to clear the writing or drawings on the screen surface thereof. The erasing signal is sent out through the electrode tip of the stylus, or a tail electrode at the tail of the stylus. However, due to limited area of the electrode tip or tail electrode, using a stylus of this kind for clearing the writing or drawings within a large surface area of a touchscreen is not an easy job.

Therefore, it is desirable to provide means for clearing the writing or drawings on the screen surface of a touchscreen conveniently and efficiently.

### SUMMARY OF THE INVENTION

The present invention has been accomplished under the circumstances in view. It is therefore the main object of the present invention to provide an electronic eraser, which comprises a carrier defining therein an accommodation chamber, at least three signal transmitters mounted in the accommodation chamber at selected locations with at least two signal transmitters disposed on the border of the accommodation chamber and at least one signal transmitter disposed around but away from the center of the accommodation chamber, and a power supply mounted in the accommodation chamber and electrically coupled with the signal transmitters for providing the signal transmitters with the necessary working electricity. When the user is going to clear the writing or drawings on the surface of the touchscreen, the user can move the carrier toward the touchscreen or position the carrier on the surface of the touchscreen, enabling the touchscreen to receive and process the signals of the signal transmitters and then to clear the writing or drawings on the surface thereof according the result of signal processing, and thus, the invention facilitates the operating convenience.

In one embodiment of the present invention, the carrier is a rectangular or square carrier with two signal transmitters respectively disposed on two opposing diagonal corners inside the accommodation chamber and one signal transmitter disposed within the accommodation chamber between the two diagonally cornered signal transmitters beyond the midpoint between the two diagonally cornered signal transmitters. In another embodiment of the present invention, the carrier is shaped like an elliptical or cylindrical prism with at least three signal transmitters positioned on the border area inside the accommodation chamber of the carrier.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a perspective view of an electronic eraser in accordance with the present invention.

FIG. 2 is a schematic sectional top view of one embodiment of the present invention, illustrating one signal transmitter disposed on the straight line between two diagonally cornered signal transmitters beyond the midpoint therebetween.

FIG. 3 is a schematic sectional top view of another embodiment of the present invention, illustrating one signal transmitter disposed beyond the straight line between two diagonally cornered signal transmitters.

FIG. 4 is a schematic sectional top view of still another embodiment of the present invention, illustrating three signal transmitters disposed on the border of the accommodation chamber of the elliptical carrier.

FIG. 5 is a schematic sectional top view illustrating one signal transmitter disposed on the midpoint of the straight line between two diagonally cornered signal transmitters.

FIG. 6 is a schematic drawing illustrating an application status of the electronic eraser.

### DETAILED DESCRIPTION OF THE PREFERRED EMBODIMENT

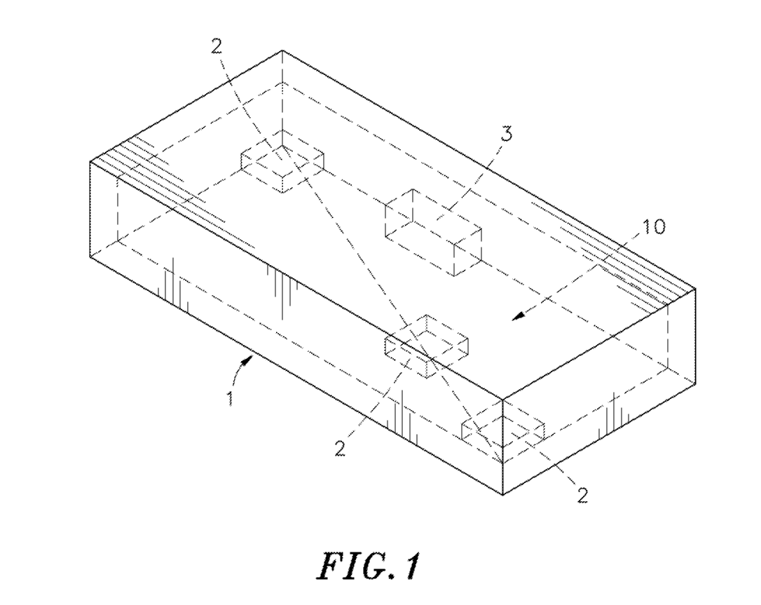

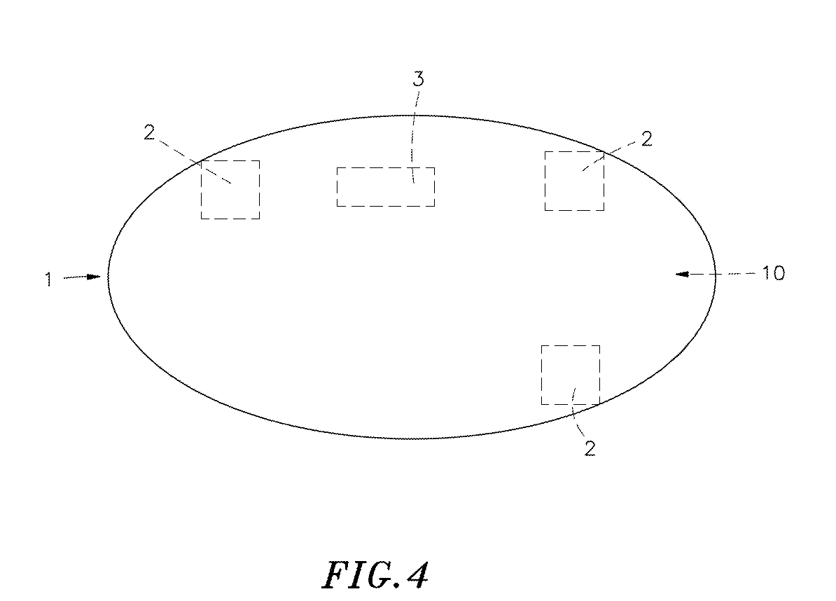

Referring to FIGS. 1-4, an electronic eraser in accordance with the present invention is shown. The electronic eraser generally comprises a carrier 1, a signal transmitter 2 and a power supply 3.

The carrier 1 comprises an accommodation chamber 10, at least three signal transmitters 2 accommodated in the accommodation chamber 10, and the power supply 3 accommodated in the accommodation chamber 10 and electrically coupled with the signal transmitters 2 for providing the signal transmitters 2 with the necessary working electricity. In one mounting example of the present invention, two signal transmitters 2 are positioned on the border area of the accommodation chamber 10, and at least one signal transmitter 2 is disposed inside the accommodation chamber 10 beyond the midpoint between the two signal transmitters 2 that are positioned on the border area of the accommodation chamber 10. When the electronic eraser is approaching or moved into contact with the surface of a touchscreen 4, the signals emitted by the signal transmitters 2 can be detected by the touchscreen 4 so that the touchscreen 4 can determine the positions of the signal transmitters 2. Because the design of these signal transmitters 2 is of the known art and not within the scope of the spirit of the present invention, no further detailed description in this regard will be necessary.

The carrier 1 has a power switch (not shown) mounted on the outside wall thereof and electrically connected with the power supply 3 for allowing a user to turn on/off the conduction between the power supply 3 and the signal transmitters 2. Preferably, this power switch is a pushbutton switch. However, in actual application, induction switch or toggle switch can be used as a substitute. As the power switch is a known device, it is not necessary to provide further description in this regard.

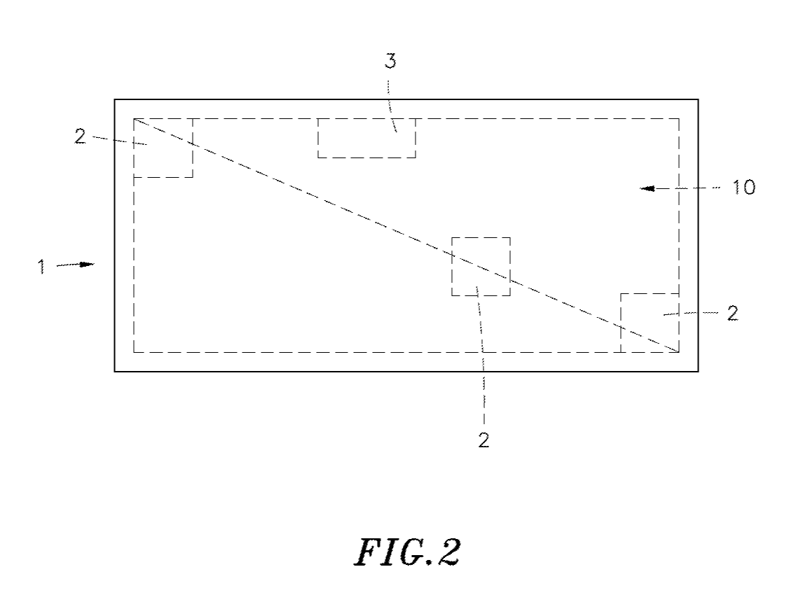

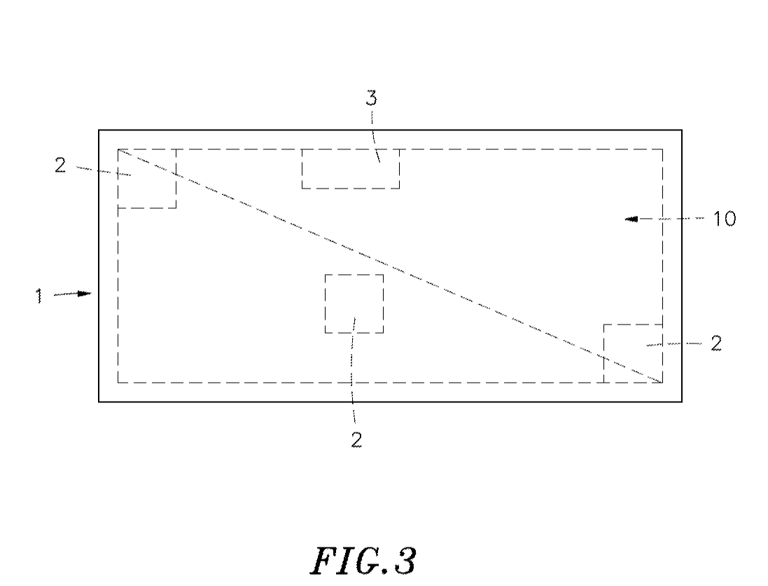

Further, in the case that the carrier 1 exhibits a rectangular or square shape, two signal transmitters 2 are respectively positioned on two opposing diagonal corners inside the accommodation chamber 10 of the carrier 1, and at least one signal transmitter 2 is disposed inside the accommodation chamber 10 beyond the midpoint between the two signal transmitters 2 that are positioned on the two opposing diagonal corners inside the accommodation chamber 10. Each other signal transmitter 2 that is not disposed on any corner can be disposed on the straight line between the two cornered signal transmitters 2 beyond the midpoint between the cornered two signal transmitters 2 (see FIG. 2) or any location beyond the straight line between the two cornered signal transmitters 2 (see FIG. 3).

In the case that the carrier 1 has the shape of an elliptical or cylindrical prism, at least three signal transmitters 2 are positioned on the border area inside the accommodation chamber 10 of the carrier 1. Thus, the bordered at least three signal transmitters 2 can be activated to transmit signals to the touchscreen 4 for erasing selected writing traces from the touchscreen 4. Further, the carrier 1 of elliptical or cylindrical prism shape facilitates gripping of the carrier 1 by the user's hand.

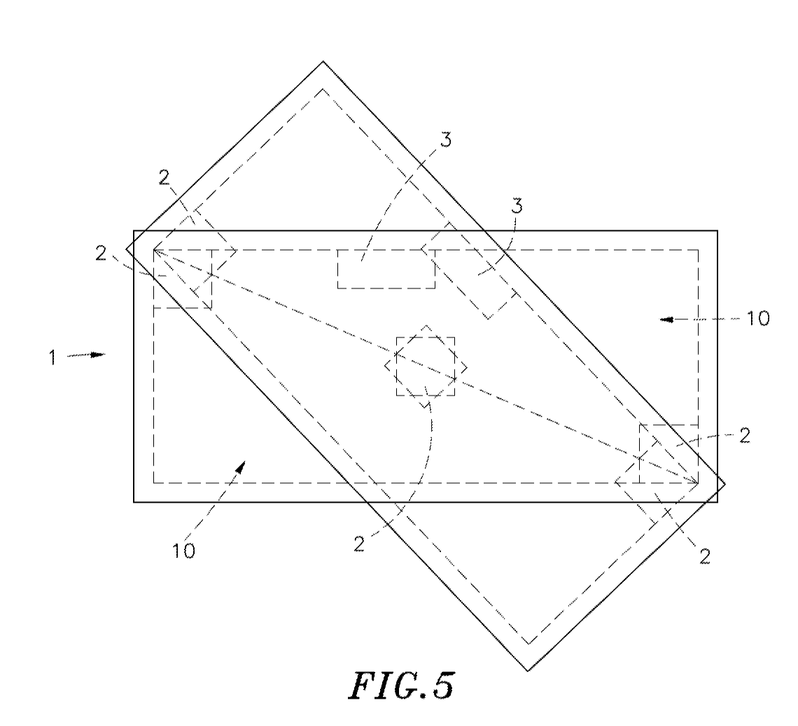

Referring to FIG. 5, if the carrier 1 is a rectangular or square carrier and if one signal transmitter is positioned on the midpoint of the straight line between two diagonally cornered signal transmitters, i.e., on the center of the carrier 1, when the electronic eraser is positioned in a horizontal position, the centered signal transmitter 2 is disposed inside the accommodation chamber 10 of the carrier 1 between the two cornered signal transmitters 2 that are respectively disposed on the upper left corner and lower right corner inside the accommodation chamber 10, however, when the electronic eraser is positioned in an inclined position, an overlap of the three signal transmitters 2, i.e., an overlap of the centered signal transmitter 2 on the center of the accommodation chamber 10 of the carrier 1 and the signal transmitters 2 on the two opposing diagonal corners can occur; because the two diagonally cornered signal transmitters 2 are located on different locations within the accommodation chamber 10 of the carrier 1, the position of carrier coverage will have no overlap, and thus, it will be unable to determine the area to be cleared.

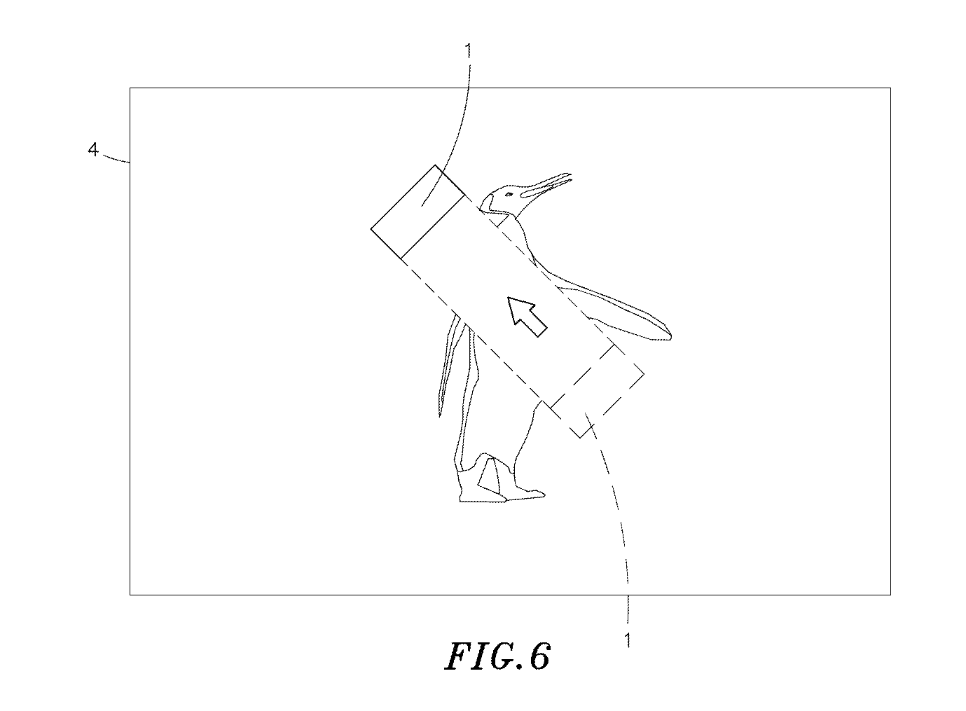

Referring to FIG. 6, in application of the electronic eraser constructed according to the embodiment with two signal transmitters 2 respectively positioned on two opposing diagonal corners inside the accommodation chamber 10 of the carrier 1 and at least one signal transmitter 2 disposed inside the accommodation chamber 10 beyond the midpoint between the two diagonally cornered signal transmitters 2, the touchscreen can calculate the configuration of the carrier 1 of the electronic eraser to be rectangle or square using the signals emitted by the signal transmitters 2; in application of the electronic eraser constructed according to the embodiment with at least three signal transmitters 2 positioned on the border of the accommodation chamber 10, the touchscreen 4 can calculate the configuration of the carrier 1 of the electronic eraser to be of circular or elliptical shape using the signals emitted by the signal transmitters 2. When the user places the electronic eraser on the touchscreen 4, the touchscreen 4 calculates the area within which the writing of drawings on the touchscreen 4 to be cleared according to the signals received from the at least three signal transmitters 2. In one embodiment of the present invention, the area within which the writing of drawings on the touchscreen 4 to be cleared is substantially equal to the contact surface area between the carrier 1 and the touchscreen 4 when the carrier 1 is positioned on the surface of the touchscreen 4, or substantially equal to the surface area of the carrier 1 when the carrier 1 is held in proximity to the surface of the touchscreen 4, facilitating operation. Further, with a large size design of the carrier 1, the electronic eraser is practical for clearing the writing or drawings within a large surface area on the touchscreen 4, accelerating the erasing speed.

In conclusion, the invention provides an electronic eraser, which comprises a carrier 1 defining therein an accommodation chamber 10, at least three signal transmitters 2 mounted in the accommodation chamber 10 at selected locations with at least two signal transmitters 2 disposed on the border of the accommodation chamber 10 and at least one signal transmitter 2 disposed around but away from the center of the accommodation chamber 10, and a power supply 3 mounted in the accommodation chamber 10 and electrically coupled with the signal transmitters 2 for providing the signal transmitters 2 with the necessary working electricity. When the user is going to clear the writing or drawings on the surface of a touchscreen 4, the user can move the carrier 1 toward the touchscreen 4 or position the carrier 1 on the surface of the touchscreen 4, enabling the touchscreen 4 to receive and process signals of the signal transmitters 2 and to clear the writing or drawings on the surface thereof according the result of signal processing.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. An electronic eraser for clearing the writing or drawings on a touchscreen, comprising:
a carrier defining therein an accommodation chamber;
at least three signal transmitters mounted inside said accommodation chamber at selected locations with two said signal transmitters on the border of said accommodation chamber, and at least one said signal transmitter mounted inside said accommodation chamber and disposed between two said bordered signal transmitters beyond the midpoint therebetween; and
a power supply mounted inside said accommodation chamber of said carrier and electrically coupled with said signal transmitters for providing said signal transmitters with the necessary working electricity;
wherein said carrier is horizontally placed on the surface of said touchscreen, said touchscreen receives signals transmitted by at least three said signal transmitters and determines the position of each said signal transmitter according to the received signals, and then calculates the erase area that is equal to the area of the shape of said carrier according to the positions of said signal transmitters in said carrier so as to clear the writing or drawings within said erase area.

2. The electronic eraser as claimed in claim 1, wherein said carrier has a rectangular or square shape; two said signal transmitters are respectively disposed on two opposing diagonal corners inside said accommodation chamber and one said signal transmitter is disposed within said accommodation chamber between said two diagonally cornered signal transmitters beyond the midpoint between said two diagonally cornered signal transmitters.

3. The electronic eraser as claimed in claim 1, wherein said carrier is shaped like an elliptical or cylindrical prism and, at least three said signal transmitters are positioned on the border area inside said accommodation chamber of said carrier.
